(19) United States
(12) Patent Application Publication
(10) Pub. No.: US 2003/0219504 A1
(43) Pub. Date: Nov. 27, 2003

(54) Pressure measuring device for an injection molding machine

(75) Inventors: Kittappa Gowda Harish, Chennai (IN); Georg Michael Ickinger, Graz (AT); Mangalasseril Saju, Chennai (IN); Shanmugham Sivakumar, Chennai (IN); Sukumaran Vivek Anand, Chennai (IN); Mathrubootmam Kumar, Chennai (IN)

Correspondence Address: Henry M. Feiereisen, Suite 3220, 350 Fifth Avenue, New York, NY, 10118, US

(73) Assignees: DEMAG ERGOTECH GMBH, Schwaig (DE); L&T-DEMAG PLASTICS MACHINERY PRIVATE LIMITED, Chennai (IN)

(21) Appl. No.: 10/387,228

(22) Filed: Mar. 12, 2003

(30) Foreign Application Priority Data
Mar. 13, 2002 (DE) 102 10 923.0

(51) Int. Cl. B29C 45/77

(52) U.S. Cl. 425/145; 425/149

(57) ABSTRACT

A pressure measuring device for an injection molding machine, includes a stroke drive mechanism operatively connected to a plasticizing unit of an injection molding machine, a force transmission member elastically deforming in response to an axial force and having one side facing the drive mechanism and another side facing the plasticizing unit. Each side of the force transmission member has at least two elevated supports, wherein the supports on one side are positioned in offset relationship to the supports of the other side. A sensor element is provided to measure a bending deformation of the force transmission member in a peripheral area thereof between two supports of the force transmission member for determining the injection pressure.

### CROSS-REFERENCES TO RELATED APPLICATIONS

This application claims the priority of German Patent Application, Serial No. 102 10 923.0, filed Mar. 13, 2002, pursuant to 35 U.S.C. 119(a)-(d), the disclosure of which is incorporated herein by reference.

### BACKGROUND OF THE INVENTION

The present invention relates, in general, to a pressure measuring device for an injection molding machine.

U.S. Pat. No. 4,950,146 describes a motor control device for an injection molding machine, using a load cell to measure the pressure by which an injection compound is pressed into an injection mold by determining the force acting upon the plasticizing screw during the injection phase. The load cell is disposed between the plasticizing screw and a pertaining stroke drive mechanism and measures the stroke force. Conventional load cells of this type, however, fail to meet the stringent demands on precision and reliability in injection molding technology.

It would therefore be desirable and advantageous to provide an improved pressure measuring device for an injection molding machine, which obviates prior art shortcomings and which is able to improve the precision within a predetermined measuring range, even when exposed to significant mechanical and/or thermal stress.

### SUMMARY OF THE INVENTION

According to one aspect of the present invention, a pressure measuring device for an injection molding machine includes a stroke drive mechanism operatively connected to a plasticizing unit of an injection molding machine, a force transmission member elastically deforming in response to an axial force and having one side facing the drive mechanism and another side facing the plasticizing unit, each of the sides having at least two elevated supports, wherein the supports on one side are positioned in offset relationship to the supports of the other side, and a strain sensor including at least one sensor element measuring a bending deformation of the force transmission member in a peripheral area extending at a distance from a neutral bending line between two supports, which are acted upon by a force from a same direction.

The present invention resolves prior art problems by employing an elastically deformable force transmission member placed in the force path between the stroke drive mechanism and the plasticizing unit, suitably the plasticizing screw, and converting the pressure or thrust force applied by the stroke drive mechanism into a bending deformation in the form of a bending carrier borne on both side via free supports. The bending deformation is suitably measured in the peripheral zone between the support sites of the force transmission member, e.g. by using a strain gauge. In this way, the predetermined measuring range is expanded and the measuring accuracy can be best suited to the desired purpose. Even in the event a fracture causes a failure of the force transmission member, the pressure measuring device still maintains the force transmission function, although the pressure measurement is lost in this case.

According to another feature of the present invention, the force transmission member may simply be a flexible beam which is disposed at a non-rotatable force-transmitting part of the stroke drive mechanism.

According to another feature of the present invention, the stroke drive mechanism may be constructed as spindle drive including a spindle, which is constructed for rotation about a rotation axis, and a spindle nut, which is mounted on the spindle and constraint against executing a rotation, wherein the force transmission member is disposed at an end face of the spindle nut in radial symmetry to the rotation axis. In this way, the force transmission and pressure measurement is simple and accurate.

According to another feature of the present invention, the force transmission member may be constructed as circular ring shaped spring element, wherein the supports are configured as platforms on opposite end surfaces of the spring element and evenly spaced circumferentially on the end surfaces of the spring element, with the platforms of one end surface position in offset relationship to the platforms of the other end surface in circumferential direction so that the spring element deforms in an undulating way, when the axial force acts on the platforms, wherein the sensor element is constructed as strain gauge disposed in a peripheral bendable area of the spring element. The undulating deformation of the spring element, when subjected to an axial pressure, results in a great elastic deformation of the inner and outer marginal bending zones, which is measured by strain gauges attached there. As a consequence of high temperatures encountered in injection molding machines in the area of the stroke drive mechanism and the plasticizing screw, the strain gauges may be implemented in the form of fiber optic transducers.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross sectional view of a stroke drive mechanism for an injection molding machine, having incorporated a pressure measuring device according to the present invention; and

FIG. 2 is a perspective detailed view of a force transmission element of the pressure measuring device for implementing a pressure measurement.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

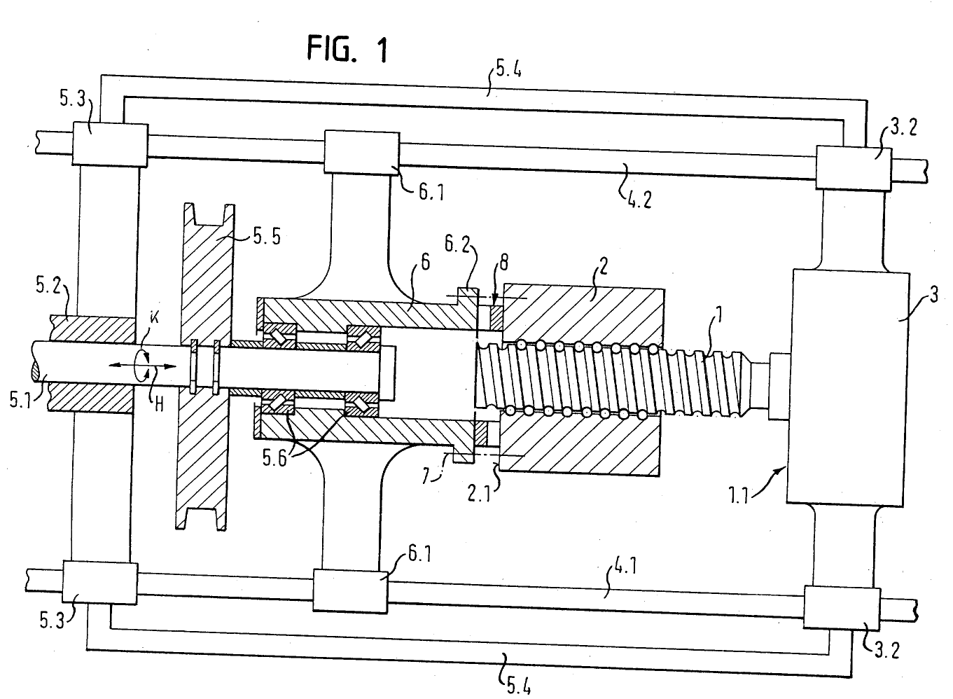

Turning now to the drawing, and in particular to FIG. 1, there is shown a cross sectional view of a stroke drive mechanism for an injection molding machine, including a spindle gear comprised of a spindle shaft 1 and a spindle nut 2. An electric rotary motor 1.1 causes the spindle shaft 1 to rotate in both rotation directions, while being axially fixed in relation to the rotary motor 1.1. The rotary motor 1.1 has a housing 3 which includes guide sleeves 3.2 for sliding securement to two parallel fixed guide rods 4.1, 4.2. The injection molding machine includes a plasticizing screw 5.1 which is received in a heatable plasticizing barrel 5.2 and operated for rotation via a pulley 5.5. The plasticizing cylinder 5.1 is movably mounted via guide sleeves 5.3 to the guide rods 4.1, 4.2 and immovably linked via frame portions 5.4 to the motor housing 3. A rotation of the plasticizing screw 5.1 advances injection compound, e.g. a plastic mass, to the nozzle end of the plasticizing cylinder 5.2. A subsequent movement of the plasticizing screw 5.1 in axial direction delivers the injection material to the injection mold (not shown).

The plasticizing screw 5.1 has a rearward end which is rotatably supported by a bearing unit 5.6 and fixedly secured in a pressure casing 6 which is also mounted via guide sleeves 6.1 for movement in axial direction to the guide rods 4.1, 4.2. On its side facing the spindle nut 2, the pressure casing 6 has a flange 6.2 provided with bores for attachment via screw fasteners 7 to an end surface 2.1 of the spindle nut 2, whereby the screw fasteners 7 are received in the bores of the flange 6.2 with clearance. The spindle nut 2 is thus non-rotatably guided via the pressure casing 6 and moves in axial stroke direction (double arrow H) as the spindle shaft 1 rotates in a direction indicated by the double arrow K.

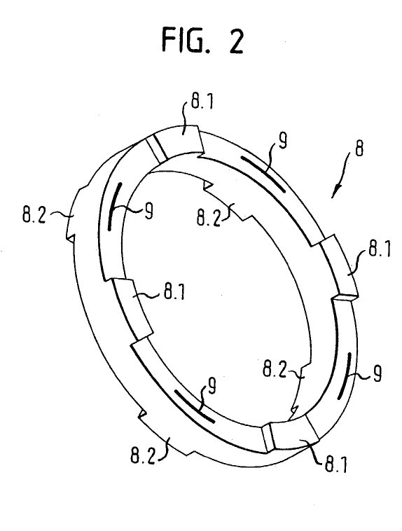

Disposed in a gap between the end surface 2.1 of the spindle nut 2 and the flange 6.2 of the of the pressure casing 6 is a force transmission member in the form of a ring-shaped spring element, generally designated by reference numeral 8, for measuring an axial pressure force between the spindle nut 2 and the flange 6.2 and plasticizing screw 5.1. As shown in FIG. 2, which is a perspective view of the force transmission member, it can be seen that the spring element 8 has a cylindrical configuration and has opposite end surfaces, with one end surface formed about its circumference with spaced-apart supports 8.1. in the form of elevated platforms, and with the other end surface formed about its circumference with spaced-apart supports 8.2 the form of elevated platforms, whereby the supports 8.1 of one side are disposed in offset relationship to the supports 8.2 on the other side of the spring element 8. As an axial pressure force is applied on the supports 8.1, 8.2, e.g. when the spindle nut 2 is advanced in the direction of the pressure casing 6, the spring element 8 is bent in a wavy fashion, whereby the inner and outer end surfaces undergo a significant deformation. In the areas of greatest deformation, sensors in the form of strain gauges 9 are attached for measuring the deformation electrically, or optoelectrically, when using fiber optic transducers. By using the measuring values ascertained by the strain gauges 9, a very precise control and adjustment of the stroke drive mechanism for the plasticizing screw 5.1 can be realized.

The spring element 8 is so dimensioned stiff enough to maintain a range of elastic deformation, when taking into account the height of the supports 8.1, 8.2 and the maximum pressure force, i.e. the spring element 8 cannot be squeezed to an extent that the platforms 8.1, 8.2 can impact confronting areas of the flange 6.2 of the pressure casing 6 and the end surface 2.1 of the spindle nut 2, respectively.

Each side of the spring element 8 should have at least two of such supports 8.1, 8.2, although a greater number of supports and corresponding increase in strain gauges 9 may be more suited to eliminate possible presence of measuring errors as a consequence of asymmetries in the stroke drive mechanism. The screw fasteners 7 are also used to provide the spring element 8 with a predetermined tension and to correct possible non-axial forces as a result of manufacturing accuracies.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A pressure measuring device for an injection molding machine, comprising:
a stroke drive mechanism operatively connected to a plasticizing unit of an injection molding machine;
a force transmission member elastically deforming in response to an axial force and having one side facing the drive mechanism and another side facing the plasticizing unit, each of the sides having at least two elevated supports, wherein the supports on one side are positioned in offset relationship to the supports of the other side; and
a strain sensor including at least one sensor element measuring a bending deformation of the force transmission member in a peripheral area extending at a distance from a neutral bending line between two supports, which are acted upon by a force from a same direction.

2. The pressure measuring device of claim 1, wherein the force transmission member is disposed between a plasticizing screw of the plasticizing unit and the stroke drive mechanism and deformed by bending in correspondence to an injection pressure.

3. The pressure measuring device of claim 1, wherein the stroke drive mechanism is constructed as spindle drive including a spindle, which is constructed for rotation about a rotation axis, and a spindle nut, which is mounted on the spindle and constraint against executing a rotation, said force transmission member being disposed at an end face of the spindle nut in radial symmetry to the rotation axis.

4. The pressure measuring device of claim 1, wherein the force transmission member is constructed as circular ring shaped spring element, wherein the supports are configured as platforms on opposite end surfaces of the spring element and evenly spaced circumferentially on the end surfaces of the spring element, with the platforms of one end surface position in offset relationship to the platforms of the other end surface in circumferential direction so that the spring element deforms in an undulating way, when the axial force acts on the platforms, wherein the sensor element is constructed as strain gauge disposed in a peripheral bendable area of the spring element.

5. The pressure measuring device of claim 1, wherein the sensor element is a fiber optic transducer.

6. The pressure measuring device of claim 1, wherein the force transmission member is a flexible beam.

7. The pressure measuring device of claim 4, wherein each end surface of the spring element has four of said platforms and four of said strain gauges with the platforms and the strain gauges disposed in alternating sequence.
